(19) United States
(12) Patent Application Publication
(10) Pub. No.: US 2016/0035020 A1
(43) Pub. Date: Feb. 4, 2016

(54) MULTIPLE OPTION AUCTION METHOD AND SYSTEM

(71) Applicant: OzB2B Pty Ltd, Melbourne (AU)

(72) Inventor: Anthony Gert DU PREEZ, Melbourne (AU)

(21) Appl. No.: 14/881,702

(22) Filed: Oct. 13, 2015

Related U.S. Application Data
(63) Continuation of application No. 11/572,624, filed on Jan. 24, 2007.

(30) Foreign Application Priority Data
Sep. 13, 2005 (AU) 2005905045
Mar. 23, 2006 (AU) 2006901525

(51) Int. Cl. G06Q 30/08

(52) U.S. Cl. CPC G06Q 30/08

(57) ABSTRACT

The present invention relates generally to a method and system for conducting online auctions. It has particular application in conducting business over a network of computers such as the Internet, for establishing materials or service supply or sales contracts, agreements for allocation of resources, etc. In particular, the invention relates to the use of multiple options within an online auction scenario. In one form, the invention provides a method for conducting an online auction event to establish a contract, the event conducted between a controlling party and at least two parties from a prescribed panel of qualified competing bidding parties, each competing bidding party operating a bidding computer, the online auction event including at least two alternative contract options potentially acceptable to said controlling party, the online auction event conducted by receiving bids from respective bidding computers, automatically comparing, during the online auction event, the respective bids and the respective contract options involving those bids, and selecting from said alternative contract options to award the contract on the basis of the comparisons.

### CROSS-REFERENCE TO RELATED APPLICATION

This application is a continuation of U.S. patent Ser. No. 11/572,624 entitled “Multiple option auction method and system” filed on Jan. 24, 2007, which is a National Stage application under 35 U.S.C. §371 of PCT Application No. PCT/AU06/01337 having an International Filing Date of Sep. 13, 2006, which designated the United States, which PCT Application claimed the benefit of Australia Patent Application No. 2005905045 filed Sep. 13, 2005, and Australia Patent Application No. 2006901525 filed Mar. 23, 2006, the entire disclosure of which are hereby incorporated herein by reference.

### FIELD OF THE INVENTION

The present invention relates generally to a method and system for conducting online auctions. It has particular application in conducting business over a network of computers such as the Internet, for establishing materials or service supply or sales contracts, agreements for allocation of resources, etc. In particular, the invention relates to the use of multiple options within an online auction scenario.

### BACKGROUND

Competitive bidding can deliver significantly better strategic sourcing outcomes when compared to traditional tender processes, and particularly the ‘sealed bid’ approach. This statement is no longer in dispute, as all Fortune 500 companies have adopted online competitive bidding tools in their strategic sourcing departments.

More recently, to make competitive bidding useful for strategic sourcing professionals, vendors have developed Total Cost of Ownership (TCO) functionality as part of their competitive bidding processes. TCO refers to a holistic view of costs, where supplier pricing is decomposed into individual cost drivers for opportunities to alter or unbundle supplier costs. Broadly speaking, there are two accepted techniques for incorporating TCO into the competitive bidding process, notably ‘transformational bidding’, and ‘target bidding’. The former technique is the solution of choice for auction facilitators such as Freemarkets and eBreviate, whilst the latter technique has been developed by the present applicant.

In applicant's published application WO-02/21347, a ‘factored bidding’ online supply contract system and method is described. The system, involving a computer network including at least one buyer computer, an administrator computer and at least two supplier computers, makes it possible for a buyer to establish an underlying base supply contract with multiple approved suppliers, to prepare a ‘Request for Quotation’ (RFQ) and issue this as a Purchasing Requirement, such as a ‘Bill of Materials’ to those approved suppliers, and then to conduct an online bidding event over the computer network between panel members who choose to validate the Purchasing Requirement. In this bidding process, prescribed ratings are applied (by way of supplier penalties attributed) automatically to offers received from respective suppliers, in order to factor relevant supplier-specific qualification attributes (e.g. quality of goods or service, risk, switching cost, experience, track record) into the tender process. When applied in a so-called ‘reverse auction’ event to establish a sourcing agreement, the invention therefore affords dynamic comparison of offers as suppliers bid downwardly against one another to achieve the best result (lowest factored bid) for the buyer. The system and method described above has been tested extensively and shown to provide significant advantages over other approaches to conducting online auctions.

The system includes means for target bid setting, to provide each bidder (supplier) with a ‘target bid’ (also referred to as a ‘current bid to win—‘CBTW’), in respect of the supply contract, the target bid calculated by the administrator computer to dynamically indicate to a supplier the offer that that supplier must submit to compete with the best previous offer, once the respective ratings have been applied to the various offers put forward. Once the lowest factored bid is calculated, in order to provide the other suppliers with an opportunity to submit competitive counter bids, a valid bid can only be one at or below their ‘target bid’ which is calculated by taking the best factored bid across the supplier panel, applying the particular supplier's factor (e.g. subtracting a prescribed penalty for that supplier) and then further subtracting a bid decrement to arrive at a target bid for that supplier. The system thus calculates a target bid for the suppliers in real time; as new bids are submitted the system constantly automatically calculates a new target bid for each supplier. This continues until suppliers have bid down to their respective individual ‘floor bids’ and no more competition exists, so the bidding stops. At the close of the auction event (under the rules of the method, the event is run for a fixed period of time, such as thirty minutes), the contract is awarded automatically to the supplier with the lowest factored bid (provided that the reserve price, if set, has been reached). The leading factored bid is then accepted and all the participants notified whether they have been successful or not.

The pre-event factoring allows the buyer to make the commitment that all relevant differences between the suppliers have been factored in, and that every supplier invited to bid has an opportunity to win the contract (i.e. there can be no ‘dummy bidders’). This has been shown to be—understandably—a key issue for suppliers, and changes the competitive dynamics considerably. Importantly, the buyer makes the commitment to all suppliers bidding in the event that the contract will be automatically awarded (if the reserve price is reached), which has significant value and maintains a credible interaction between the parties.

Preferably, the method also involves sharing with the panel of suppliers information about how the factor penalty is derived, in the form of a ‘supplier performance scorecard’. This provides the maximum transparency, enabling suppliers to consider and manage initiatives for improving their rating and therefore minimizing the penalties applied against them in the factoring process in future events.

The invention can equally be applied to the more traditional ‘forward auction’ type of event for allocation of goods services or resources between competing bidders, affording dynamic comparison of offers as potential buyers bid upwardly against one another to achieve the best result (highest factored bid) for the seller.

The factored bidding approach described in application WO-02/21347 is concerned with a single panel of competitive suppliers in a single lot auction. There are situations where auction processes may involve considerably more complex scenarios, such as multiple auctions (i.e. multiple panels) or multiple bids, either because multiple lots are on offer, or because the auction may extend to a plurality of events.

For example, U.S. Pat. No. 6,415,270 describes a multi-auction service system and method for increasing visibility of an item to be auctioned by mirroring it at a plurality of remote auction services, such that an optimal bid can be automatically replicated at each of the remote auction services. WO-2000/17797 describes a lot closing extension feature for use in multiple lot B2B auction events. If two lot periods are to finish too closely together, one lot period is automatically extended to ensure that consumer bidders are able to pay full attention to one lot at a time.

It would be desirable to apply the advantages of a factored bidding approach to these more complex auction events, without losing the integrity and transparency of the overall process, and in particular it would be desirable to apply this approach to alternative auction scenarios to enable real-time optimization of supply chain choices.

Any discussion of documents, acts, materials, devices, articles and the like is included in this specification solely for the purpose of providing a context for the present invention. It is not suggested or represented that any of these matters formed part of the prior art base or were common general knowledge in the field relevant to the present invention as it existed in Australia or elsewhere before the priority date of any claim of this application.

### SUMMARY OF THE INVENTION

It is an object of the present invention to at least partly address the inconveniences of the prior art, or to provide a new approach to online auctions. To this end, in broad view, there is provided a method for conducting an online auction event to establish a contract, the event conducted between a controlling party and at least two parties from a prescribed panel of qualified competing bidding parties, each competing bidding party operating a bidding computer, the online auction event including at least two alternative contract options potentially acceptable to said controlling party, the online auction event conducted by receiving bids from respective bidding computers, automatically comparing, during the online auction event, the respective bids and the respective contract options involving those bids, and selecting from said alternative contract options to award the contract on the basis of the comparison.

The method of the invention can thus be carried out to establish a contract for supply or allocation of goods, services or resources, and finds application in a wide variety of different industries and types of arrangements.

It will be understood that, in a situation in which an auction lot may be satisfied by a combination of two or more sub-lots, the resulting contract may thus be a contract arrangement involving a number of successful bidders, all part of the same winning option.

At least one of said alternative contract options may therefore involve two or more subcontracts, each subcontract to be awarded in a sub-auction bidding event, and the method preferably includes the steps of:

allocating, by or on behalf of the controlling party, respective bidding party factors to said competing bidding parties, each factor to be applied to bids received from the respective party's bidding computer before comparison with any other bid in the sub-auction bidding event; and

conducting the online auction event by conducting all the sub-auction bidding events simultaneously and applying said respective bidding party factors to bids received from said bidding computers (to arrive at respective factored bids), for comparison during the auction event between the different bids and between the different options.

In a preferred form, the method further includes the steps of:

allocating, by or on behalf of the controlling party, respective option factors to said contract options, each option factor to be applied to calculations with respect to the associated contract option before comparison with any other contract option; and

during the online auction event, also applying said respective option factors to bids received from said bidding computers (to arrive at said respective factored bids) for comparison during the auction event between the different bids and between the different options.

The comparison between different contract options may be carried out by comparing leading factored bids, and/or leading combinations of factored bids in respective sub-auction bidding events, between the different options.

The comparison between different options is thus carried out in order to automatically select the auction result that gives the best overall value to the controlling party, in other words, the best overall cost once all relevant factors have been applied. It will be understood that the winning option may be a single contract with a single supplier or purchaser, of may be a multi-party contract made up of a number of contracts (or ‘subcontracts’) with respective different suppliers or purchasers.

Preferably, the method includes the steps of:

simultaneously conducting the sub-auction bidding events by receiving bids for the sub-auction bidding events from said bidding computers of the competing bidding parties for automatic comparison during the auction event between the different bids and between the different options; and

during the online auction event, providing to each bidding computer a first target bid indicating the bid that that party must make to be the leading bid in a sub-auction bidding event in which that party is involved, and a second target bid indicating the bid that that party must make to ensure the option in which that sub-auction bidding event is involved is a leading option in the auction event.

A sub-auction bidding event thus represents an auction between two or more parties for a particular lot, which may of course be a sub-lot of an overall lot, other sub-lots of that overall lot being the subject of other simultaneous sub-auction events. Hence, a bidder may bid successfully in a particular sub-auction event, but fail to secure a contract if the option in which that sub-auction event is involved is not a winning option. Of course, in the auction event, a particular bidder may choose to bid in more than one option, and/or in more than one sub-auction event.

Preferably, said first target bid is calculated by the steps of:

comparing, in a sub-auction bidding event, received bids from the competing bidding parties to which bids said bidding party factors have been applied;

establishing, in accordance with that comparison, a leading bid in that sub-auction bidding event; and

applying the bidding party factors and a minimum bid increment or decrement to said leading bid to arrive at a target bid for each bidding party in that sub-auction bidding event.

Said second target bid may be calculated by the steps of:

comparing the competing options;

establishing, in accordance with that comparison, a bid or bid combination representing a leading option in the auction event; and

calculating, on the basis of that leading option, an option target bid for each bidding party involved in other sub-auction bidding events by applying the bidding party factors and a minimum bid increment or decrement to arrive at option target bids for bidding parties in said other sub-auction bidding event.

The method may include the step of:

allocating, by or on behalf of the controlling party, respective option factors to said contract options, each option factor to be applied to calculations with respect to a contract option before comparison with other contract options;

wherein said respective option factors are also used to calculate, on the basis of said leading option, the option target bid for each bidding parties involved in said other sub-auction bidding events.

Where at least one contract option involves two or more subcontracts, each subcontract to be awarded as a sub-auction bidding event, the method may include the steps of:

specifying, by or on behalf of said controlling party, a contribution weighting for each subcontract relative to the overall contract of that contract option;

during the online auction, providing to each bidding computer of the competing bidding parties in a sub-auction event involved in that contract option, a third target bid indicating the bid that that party must make to contribute fairly to the chances of success of that option.

Said third target bid may be calculated by the steps of:

comparing competing contract options;

establishing, in accordance with that comparison, a bid or bid combination representing a leading option in the auction event; and

calculating, on the basis of that leading option, a contribution target bid for each bidding party involved in other sub-auction bidding events by applying the contribution weighting, the bidding party factors and a minimum bid increment or decrement to arrive at a contribution target bid for bidding parties involved in said other sub-auction bidding events.

Said respective option factors may also be used to calculate, on the basis of the leading option, a contribution target bid for bidding parties involved in said other sub-auction bidding events.

In one embodiment, the auction may involve two or more different combination dimensions, giving rise to different option dimensions. In such a case, further option targets (in addition to said second target bid) may be provided to each bidder during the online auction event, indicating the bid that that party must make to ensure the further option in which that sub-auction bidding event is involved is the leading option in the auction event.

In one form of the invention, the event is a reverse-type auction, said controlling party is a buyer and said competing bidding parties are sellers.

In an alternative form, the event is a forward-type auction, said controlling party is a seller and said competing bidding parties are buyers.

Preferably, during the auction event, each target bid provided to each bidding computer is accompanied with an indicator to indicate whether or not that bidder presently holds the leading bid in respect of that target.

Further, during the auction event, each target bid provided to each bidding computer is preferably accompanied with an indicator to indicate whether or not that bidder presently holds a bid in a leading option.

The auction event may relate to a contract for a defined quantity of product(s) or service(s), and the alternative contract options involve at least one combination of smaller quantities of said product(s) or service(s) making up said defined quantity.

The online auction event may be carried out over a computer network comprising said bidding computers and an auction administrator computer operated by or on behalf of said controlling party, the auction administrator computer applying said respective factors with respect to bids received from said bidding computers and making the comparisons during the auction event between the different bids received and between the different options.

In a preferred form of the method of the invention, only a bid that satisfies said first target bid can be received from a bidding party computer. In other words, once a particular bidding party's first target has been calculated in accordance with the invention, only a bid from that satisfies this target can be submitted by that party.

It should be noted that, at any particular time, a particular bidding party's option target bid will be the same as the auction target bid if that bidding party is involved in the leading option at that point in time (as determined by the option comparison process).

The option comparison process therefore provides an automatic real time calculation mechanism whereby the auction process always awards the supply contract on the basis of the best return for the controlling party. This takes into account the respective bidding party factors and the multiple options that are simultaneously being compared.

As mentioned above, each supply contract awarded on its own or may be part of a combination contract, giving rise to multiple contract options.

In accordance with a further form of the invention, there is provided a computer-based system adapted for conducting an online auction event in accordance with the above defined methods.

### DEFINITION OF TERMS

Bidding party factor—prescribed values set by or on behalf of the controlling parties for all bidding parties. This value is applied to bids received from that party before comparison with any other bid in that sub-auction bidding event, in order to factor relevant bidding party attributes into the process. The bidding party factor may represent any, some or all of a wide range of different attributes, such as quality of goods/services, delivery time, service levels, switching cost, track record, etc). The bidding party factor may be expressed as a percentage, or as a dollar amount representing a relative penalty or discount for that particular bidding party. A bidding party factor may be able to effect change of their bidding party factor (e.g. by revising an attribute such as delivery time or payment term), either before or during an auction event, in accordance with rules set by or on behalf of the controlling party.

Contract option—from at least two alternatives, an option pre-approved by or on behalf of the controlling party that will satisfy the RFQ. Each contract option will involve at least one sub-auction bidding event.

Option factor—prescribed values optionally set by or on behalf of the controlling parties for each contract option. If set and activated, this value is used to compare the different options during the auction event (or, more properly stated, to compare the leading factored bids or factored bid combinations between the different options), and represents a relative penalty or trade-off between the options. It may be expressed as a percentage or as a dollar amount representing a relative penalty or discount for that particular contract option. If there is only a single sub-auction bidding event involved in an option, then the relevant option factor may be applied as appropriate to the leading bid in that event (once respective bidding party factors have been applied) before comparison with other options. If there are multiple sub-auction bidding events involved in and contributing to an option, then the relevant option factor may be applied as appropriate to the sum of the leading bids in those events (once respective bidding party factors have been applied).

Sub-auction bidding event—under each contract options, at least one auction (and possibly many more) must be run contemporaneously during the overall bidding event, and these are referred to herein as ‘sub-auction bidding events’. A sub-auction bidding event may therefore relate to a component of a larger contract, or may relate to a separate option in itself

Target bid—a value provided to a bidding party as part of an auction event that indicates to that party the bid that they must submit in order to be the leading bidder. This value will generally take into account a prescribed minimum bid decrement (or increment, in the case of a forward auction). When bidding party factors and/or contract option factors have been applied, target bids will generally vary between different bidding parties.

Subcontract—a single contract option may be defined as a combination of contributory parts, referred to herein as subcontracts. For each subcontract, a panel of qualified bidding parties is established, and that subcontract is then (potentially) awarded by the running of a sub-auction bidding event between those parties.

Contribution weighting—for a subcontract, a measure of the contribution of that subcontract to the relevant contract option, expressed as a ratio. This is optionally set by or on behalf of the controlling party. For example, for four equal subcontracts, the contribution weighting for each subcontract will be 0.25.

### BRIEF DESCRIPTION OF THE DRAWINGS

A non-limiting embodiment of the invention will now be described by way of example, with reference to the accompanying drawings, in which:

FIG. 1 schematically illustrates a system for carrying out the method of the invention;

FIG. 2 schematically illustrates a multi-option auction scenario;

FIG. 3 illustrates in tabular form the calculations carried out as part of the process of factoring of starting prices, as well as the target bids provided to participants, in a multi-option auction event carried out in accordance with the present invention; and

FIG. 4 is a screenshot of an auction page displayed to a registered bidder during an auction event conducted in accordance with the invention.

### DETAILED DESCRIPTION OF THE INVENTION

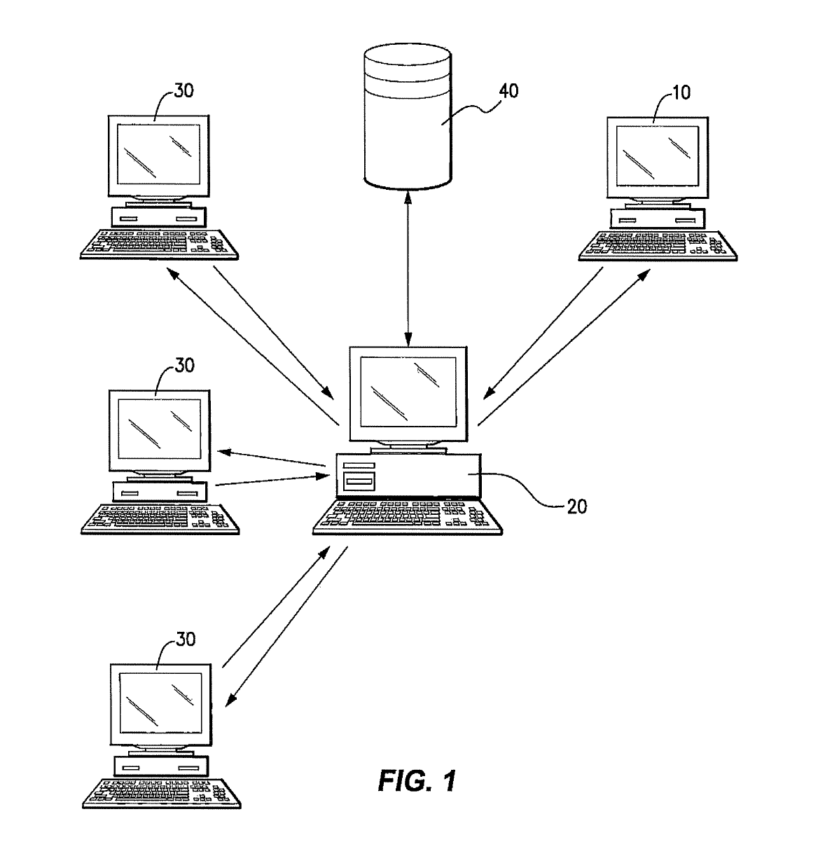

A form of the electronic system to which the invention may be applied is described in detail in published application WO-02/21347. As discussed above, this system involves so-called ‘factored bidding’, which (in the context of a reverse auction) allows the buyer to set supply criteria for a particular subcategory of materials (a so-called ‘reverse factored auction’). The system, as shown in FIG. 1, includes a computer network including at least one buyer computer 10, an administrator computer 20 and at least two supplier computers 30.

These components are linked via the Internet or any other appropriate network system (not shown). The administrator computer that controls the auction event on behalf of the buyer is likely to be operated by a facilitator organization providing the auction service to the buyer organization (or seller organization, in the case of a forward auction). However, it should be noted that the system does not need to be third party controlled; it can be initialized, updated and controlled by the procurement specialist within a buyer organization, for example. The buyer computer 10 and the administrator computer 20 may therefore be provided on a single computer system of the buyer organization. A computer software application comprising the prescribed auction rules is used to manage and to run the auction event, the computer software application having a client component operating at the supplier computers 30, and a server component operating at the administrator computer 20.

Administrator computer 20 is connected to database 40 which stores data regarding suppliers and auction events, and this data can be used to help buyers make decisions about the rating of particular suppliers (see below).

The present invention relates to a situation where a buyer has multiple options to choose from, and where these options are different but all represent potentially satisfactory outcomes. The invention affords the buyer the opportunity to factor the differences between the plurality of options, and to compare the options in an online real-time transparent competitive bidding process, in order to optimize the alternative supply chain solutions available.

Each option has more than one qualified supplier able to compete for the contract, and one or more of the options may be made up of a combination of more than one sub-auction bidding event, so as to require multiple suppliers to contribute to the chances of that option winning the overall event.

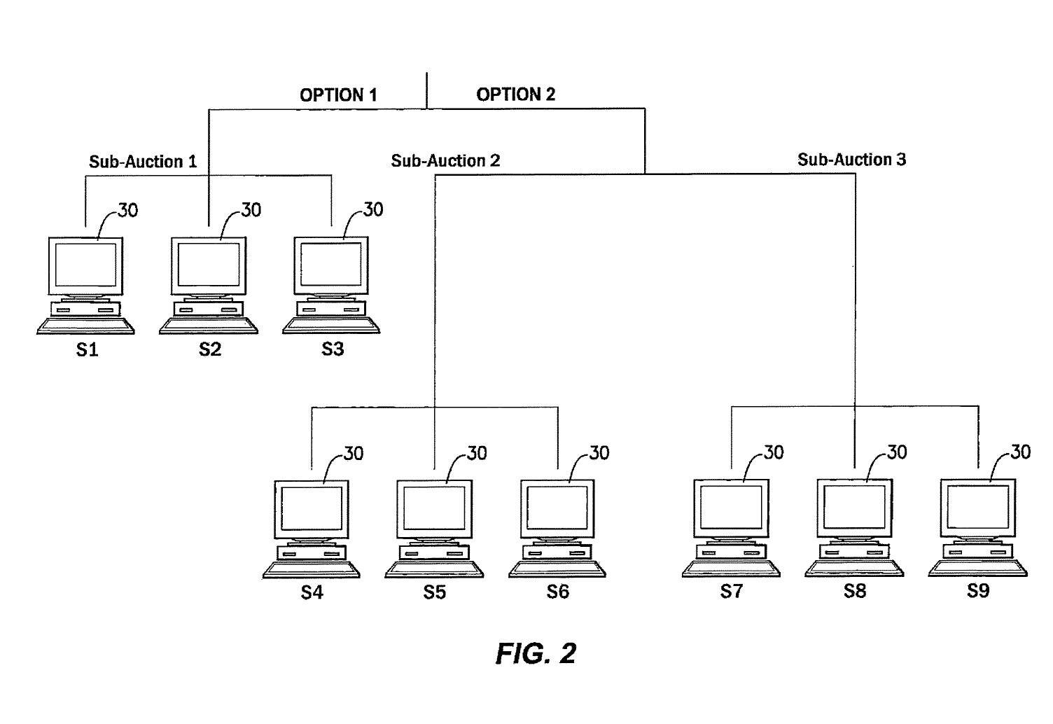

As an example, a buyer company may be looking for pest control services across a national retail operation. The company operates in two different states. The buyer has the option of awarding a national contract to a single pest control provider, or awarding a contract to a pest control provider in each state (i.e. to state-based companies). The national pest control provider may also provide state-based services. This alternative supply scenario is schematically illustrated in FIG. 2, in which the example given includes a panel of three national providers, and three state providers in each of two states. There are therefore two options, Option 1 (a contract with a national provider) or Option 2 (a contract with a combination of two state based providers), and the overall auction event will thus entail the running of three sub-auction bidding events simultaneously. Of course, a particular supplier entity may qualify on a panel under both options, as both a national and a state-based provider.

The present invention therefore provides an approach for conducting a multi-option total cost competitive bidding event. This technique applies the target bidding approach in situations where it is appropriate to select an optimal solution from multiple options. Such situations may arise, for example, in combinatorial auction scenarios, in which bidders can place bids on combinations of items (or ‘packages’), rather than simply on individual items. The ability to effectively compare the value to the controlling party of the different options arising out of such situations is key to the success of such processes. Examples include road and rail transportation for goods or passengers, airport arrival and departure slots, and allocation of radio spectrum for wireless communications services. The presence of complementarities among the items, which are likely to differ between different bidders, can provide an essential motivation for the use of the combinatorial auction. For example, a freight service's cost of handling shipments in one lane depending at least in part on its loads in other lanes.

By way of more detailed explanation, let us first consider the conventional tender process (see table below).

TABLE 1

| | Supplier | Supplier | Supplier |
|---|---|---|---|
| | 1 | 2 | 3 |
| Price $ | $70 | $90 | $80 |
| Quality Q | 80 | 90 | 70 |
| Value (Q/$) | 1.14 | 1.00 | 0.88 |

In this simple example a buyer approaches three suppliers seeking price quotes and quality responses. This information is gathered by suppliers responding to a Request for Quote (RFQ) document issued by the buyer. Suppliers respond to the RFQ with their unique price and quality combination. Quality Q in this case includes all non-price dimensions of the goods or service being offered, such as performance, risk, switching costs, etc.

The buyer scores quality out of 100 points, and the price quotes range from $70 to $90. This provides a means of assessing the price quotes for comparison, as dividing the quality by the price gives an idea of likely ‘bang for your buck’. In this example, supplier 1 has the highest value offering, with a price quote of $70 and a quality score of 80 points. Their ratio is 1.14. Clearly supplier 1 appears to the buyer to offer a better value solution than does supplier 2 on a score of 1.00 and supplier 3 on a score of 0.88.

The buyer in this case will not necessarily accept the offer as it stands from supplier 1, instead the buyer will generally choose to engage supplier 1 in a face-to-face negotiation to increase the quality offered or reduce the price, or both if possible. The objective is to increase the value being offered, and walk away from the negotiation with the best negotiated value outcome.

In shifting the buyer from a sealed bid tender process to a competitive bidding process that incorporates TCO functionality, the applicant developed the methodology described in published application WO-02/21347.

In effect, rather than exclude suppliers 2 and 3 after the first sealed bid offer, we now consider a technique which keeps all suppliers in the competitive bidding event. The target bid approach to competitive bidding requires the buyer to make quality tradeoff decisions between the suppliers, these tradeoffs being monetized or financially valued to reflect the real impact on TCO, and the impact on net profit for the profit maximizing organization.

The process of assigning dollar values to the quality tradeoff points is referred to as ‘factoring’, and the table below provides an example of the process.

TABLE 2

| | Supplier | Supplier | Supplier |
|---|---|---|---|
| | 1 | 2 | 3 |
| Q Penalty | $10 | — | $20 |
| Factored Quote | $80 | $90 | $100 |
| Decrement | $5 | $5 | $5 |
| Target Bid | $65 | $75 | $55 |

The initial stage is the decision factor analysis. From the RFQ process described above, Supplier 2 is the benchmark in terms of quality, Q=90 points. The process is primarily concerned with the relative tradeoff, not the absolute tradeoff.

In this case we assume that one quality point is equal to one dollar. So Supplier 1 with 80 quality points when compared with a Supplier 1 with 90 quality points will have a $10 impact on the TCO of the buyer. In practice, this stage is conducted by way of an iterative process of negotiation and monetizing of the quality tradeoff between stakeholders and suppliers. Once the quality tradeoff is agreed, the system is able to factor each supplier's initial quote to determine the best value deal.

In this example, therefore, Supplier 2 is assigned a Q penalty of $0, Supplier 1 with a Q score of 80 carries a Q penalty of $10, and supplier 3 a Q penalty of $20.

The Q penalty is then added to the price quote to give a ‘factored quote’, and the supplier with the lowest factored quote is considered the best value, or leading, supplier. In this case Supplier 1 has a factored quote of $80, and this is better value than Supplier 2 with $90 and Supplier 3 with $100. In effect, the process so far is identical to the sealed bid process described above.

In a competitive supply market, the buyer should not be satisfied with the initial sealed bid. Instead the alternative suppliers must be given the opportunity to adjust their bids in a transparent competitive environment. The applicant's target bidding method calculates a unique target bid for each supplier based on the ‘best factored’ quote in an auction event. In this case, Supplier 1 is the best factored quote with $80, and a Supplier 2 (with no penalty) will have to bid at $75 to better the best factored quote of $80, assuming a preset minimum bid decrement of $5. For Supplier 3, their target bid includes the decrement of $5 and their Q penalty of $20, and so Supplier 3 must bid at or below $55 to better the best factored quote of $80 bid by Supplier 1.

The starting target bids in Table 2 are the based on the suppliers initial bids (e.g. the registered suppliers' pre-auction bids), but can instead be based on an initial price specified by the buyer, to which the factoring process is applied.

Suppliers can then bid and counter bid as many times as they wish during the set event period, the only requirement being that each supplier must bid at or below their unique target bid to submit a valid bid. This is a competitive bidding event that transparently incorporates TCO into a real-time bidding event. The buyer has achieved the objective of negotiating with several suppliers in real time, and they have secured the best value deal without the subjective and closed process of conducting face-to-face negotiations. The buyer knows that they have the best outcome on the day, assuming a competitive auction environment.

As explained above, the present invention relates to a situation where a buyer has multiple options to choose from, and where these options are different but all represent potentially satisfactory outcomes. Such a situation usually involves multiple stakeholders in the sourcing process, and it is necessary to incorporate multiple stakeholder views in determining the Q penalty for each supplier. In such scenarios, there are likely to be multiple decision factors, multiple total cost variables, multiple contract award options, and multiple panels of qualified suppliers.

There is no universally recognized solution to the problem of decision making with multiple stakeholders in strategic sourcing processes, and this is perhaps the area in which professionals have the most difficulty. This can often result in unsatisfied stakeholders who may tend not to wish to comply with contracts that are negotiated, and in decision-making processes that can be long and drawn out and not necessarily result in the optimal solution. The present invention sets out to provide a process that is (as far as practicable) wholly objective, giving the stakeholders the opportunity to become involved at an early stage, to cooperating to maximize leverage and buying power in order to secure the best deal in a competitive market, and to reach consensus by way of the process to ensure that decisions are made.

The following discussion provides some theory behind the present invention.

Decision analysis theory helps industries understand how to work with groups to make decisions. It is recognized that—for an objective and therefore optimal approach—the group members must be kept separate during the initial stages of the process, thereby to avoid ‘group think’ in the decision making process. This allows each individual to make a decision based on information available to them.

In the strategic sourcing situation, the first step is to ask each stakeholder to rank the supplier against each of the relevant decision factors (i.e. the Q factors mentioned above, such as quality, performance, risk, safety, commercial terms, relationship etc). This process provides an ordinal ranking, where the order is of importance. Order alone does not give us a relative measure of the ranking, but provides a good starting point. Of course, not all stakeholders are able to assist with a rating of all the suppliers. If stakeholders can also provide not just a ranking of the suppliers, but also a rating, then we have a relative measure for each supplier against each factor. This is a cardinal ranking, as it can provide both the order and relative positions of the suppliers.

The following table gives an example of this initial process between the three suppliers:

TABLE 3

| Stakeholder | Supplier | Supplier | Supplier | |
|---|---|---|---|---|
| Input | 1 | 2 | 3 | |
| Rank suppliers | 1 | 3 | 2 | > by decision |
| | | | | factor |
| Rate suppliers | 9/10 | 4/10 | 7/10 | > by decision |
| | | | | factor |
| Reasons | | | | > by decision |
| | | | | factor |

This does not in itself provide the necessary information to quantify the tradeoff between each supplier for each stakeholder. From an objective perspective, we still do not know what a score of 9/10 signifies when compared with a score of 4/10.

The next step is therefore to obtain for each supplier a dollar tradeoff range for each factor, i.e. ascertain how much a buyer would pay for a supplier with a score of 10/10 in comparison with a supplier with a score of 0/10. This could be $100 or $1,000, and each stakeholder may well have a very different view of what those tradeoff values should be. It is necessary to give each stakeholder the opportunity to attempt to quantify the tradeoffs before bringing them together. The reasons for assigning particular tradeoff values are important in this preliminary process, as they often provide the most insight.

The table below provides an example of this multiple stakeholder process:

TABLE 4

| | | |
|---|---|---|
| Tradeoffs | Stakeholder 1 | $120 |
| | Stakeholder 2 | $100 |
| | Stakeholder 3 | $80 |
| | Average | $100 |
| | Q Range | 100 |
| | Q Tradeoff | $1.00 |

The three stakeholders have different views on how much 100 quality points are worth. Stakeholder 1 puts that value at $120, while stakeholder 3 thinks the value is $80. The average is 100 quality points equaling $100 (1 point for 1 dollar). There may be cases in which a simple averaging cannot be used—perhaps because one stakeholder has better information or more influence on the decision than others—but the process is nevertheless wholly transparent and can be audited.

### Application to a Multiple Option Auction

Returning to the pest control service example introduced above, the buyer has qualified three national providers, and three state providers in each of two states. We therefore have two state-based panels of three suppliers each, and one national panel of three suppliers. There are therefore nine suppliers that can participate in an electronic bidding event. There are two options; a contract with a national provider, or a contract with a panel of state based providers, and the overall auction event will thus entail the running of three auctions simultaneously, with a common event closing time (see example below). Of course, a single organization providing pest control services may qualify on a panel under each option, as both a national and a state-based provider.

Each supplier in each panel will be allocated an individual factor, as there will be differences in terms of capability, risk, performance, terms etc. Following an initial qualification process a cost penalty is established for each supplier on each panel. The differences between the suppliers are therefore factored in such that it is possible to use an electronic auction process for each panel to award the contract to the best value supplier in a competitive bidding process.

It is necessary to take the same approach to the different options as taken for the different suppliers (described above with respect to the competitive bidding process incorporating TCO functionality), and to factor the options from a TCO perspective.

Once a factor has been applied to each supplier, and to each option, we turn our attention to the rules of the electronic auction process. It is possible now to conduct the bidding process between the three panels as sequential auction events, then performing post-event analysis to optimize the bids, in order to award the contract to the best supplier(s) and the best option. However, to maintain the integrity of the auction methodology, the objective is to keep all the suppliers bidding in real time, so ensuring the commitment to award the contract (if the reserve price is reached) to the option and to the bidder(s) representing the best value to the buyer, as part of the bidding event.

The present invention provides an electronic auction system that allows the buyer (or seller) to engage multiple supply panels that represent different options in a real-time competitive bidding event, in which the buyer can commit to awarding the contract to the best value supply option, not simply to the best value supplier in the panel. This approach allows a plurality of options to be bid against each other in real time, maintaining the commitment to automatically award the contract.

The system enables the communication of multiple target bids to each supplier in each panel. Each supplier in a panel is provided with a target bid at or below which they must bid, calculated from the lowest factored bid in the panel. This target bid is the bid to win their auction (TBA). Each supplier is also provided with a target bid to win the option in which they are involved (TBO), as there is no point in winning their auction only to be part of the or a losing option. The approach of the invention provides the opportunity in a real time bidding system to give each supplier sufficient information so that they can bid to control their destiny within the overall bidding event, i.e. they are able to adjust their bid to win their auction and they can adjust their bid in order to ensure their option will win.

In some situations, an option will only win if the combination of the best factored bids from multiple panels represent the best total factored bid between all of the options. In other words, the sum of all factored bids for the one option is more attractive than the best total factored bid for the other options. The buyer will usually prefer one option over the other by a certain measure, and the value of this measure needs to be included in the comparison between the alternative options. For example, the buyer may denote a tradeoff value to the state-based contract option, due to a perceived risk of non-performance or other reason. In other words, the system allows the comparison of the best factored bids from each option, and additionally includes an option factor to assist in determining which option represents the best deal.

Whether or not option factors are used, the bid guidance described above can be invaluable to assist a bidder in prioritizing their activity in respect of the lots on which he is registered to bid. In particular, it can serve to inform a bidder during the auction event that he may consider not focusing on a particular lot, for example in a situation where their TBA is achievable but their TBO is not. In such a situation, the success of the relevant option may effectively be out of the control of that particular bidder, and it may be up to the action of bidders involved in other sub-auction bidding events comprised in that option in order to change the situation and make this a realistic option for continued bidding by this particular party.

For an option which includes multiple panels, the buyer may be required to give a ‘contribution weighting’ to each panel. For example, if one state is bidding to provide 30% of the total volume of the contract, and a second 60%, and a third 10%, then the system needs to calculate a third ‘target bid’ for each of these suppliers. This is a target bid for each supply panel to contribute their proportion (TBC) of the total option bid required to ensure that their option will win. Clearly, the tradeoffs between the different options and the contribution weightings should be preset before the start of the auction event, although it is possible to conduct an event where such values are adjusted by the buyer or automatically in accordance with specified criteria during the event.

During an auction event of this sort, an individual supplier is provided with three target bids, each with an indicator as to whether they are leading in respect of that target bid (by way of a red/green ‘traffic light’ provided to the user on their bidding screen display). A first target bid indicator indicates whether that supplier is the leading bidder in their auction. A second target bid indicator indicates whether their option is the leading option. Clearly, if a supplier holds a leading position in a particular auction, but their option does not hold a leading position, then they will not win the contract. The system of the invention allows a supplier to influence the whole outcome of the event. The third target bid indicator provides an indication of whether that supplier is providing the required contribution according to the contribution rating entered by the buyer.

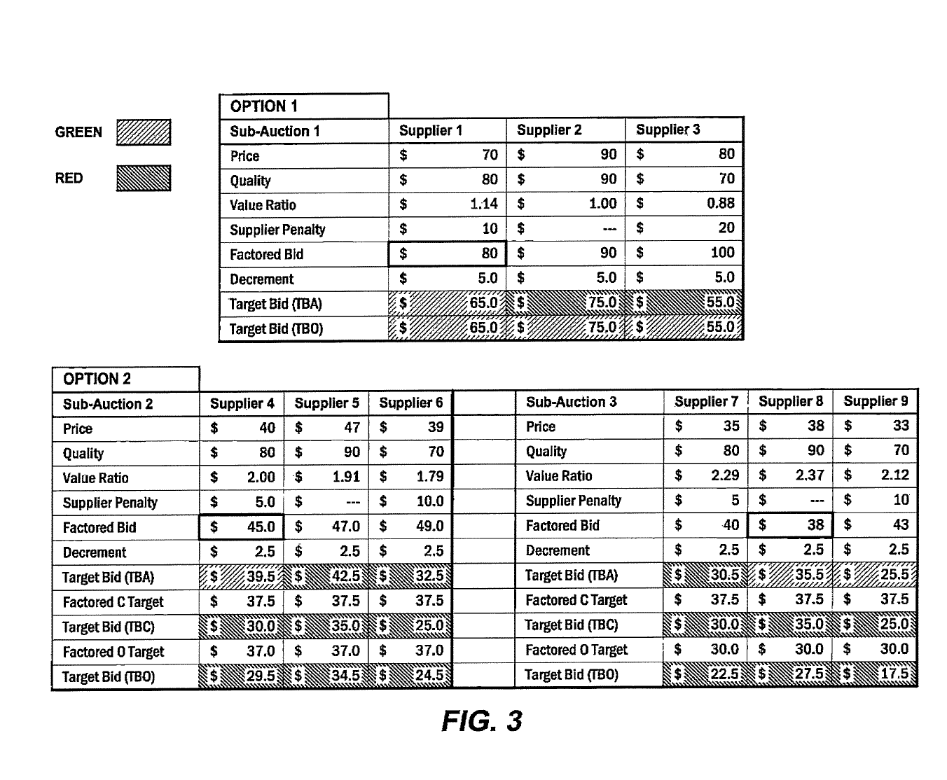

FIG. 3 illustrates an example of the starting price calculation for such an auction event, and shows the starting target bids provided to participants, in an auction where the buyer prefers the national option (Option 1) to the state-based option (Option 2), and has chosen to set a $5 tradeoff as a result. Within Option 2, Auctions 1 and 2 have each been given a 0.5 contribution factor, representing an even (50%:50%) contribution split (i.e. each sub-auction will provide half of the total contract).

The following provides explanation of the calculations carried out with respect to the auction event exemplified in FIG. 3. It is important to note that all comparisons between bids and between options are made with respect to factored bids, in order to respect the relative quality factors or trade-offs between the different suppliers and between the different options. Reference is also made to the definitions section above with respect to particularly terminology employed.

### Option 1

In accordance with the quality factors, Suppliers 1, 2 and 3 are again allocated trade-off penalties of $10, 0 and $20 respectively, to be applied to bids received before comparison with other bids. The system therefore applies these to their starting bids, to give factored bids of $80, $90 and $100 respectively, as shown. Supplier 1 thus holds the leading position at the start of this sub-auction bidding event, and target bids for the counterparties are therefore calculated relative to Supplier 1's bid. Thus, Supplier 2's target bid is calculated by the system as $80 (the leading factored bid), minus zero penalty (as Supplier 2 has a 0 penalty trade-off), minus the minimum bid decrement $5, which gives a target bid of $75. Similarly, Supplier 3's target bid is calculated by the system as $80 (the leading factored bid), minus $20 penalty (as Supplier 2 has a $20 penalty trade-off), minus the minimum bid decrement $5, which gives a target bid of $55. Although Supplier 1 holds the leading position, a new target bid can be provided to Supplier 1, calculated in just the same way ($80, minus $10 penalty—as Supplier 1 has a $10 penalty trade-off—minus the minimum bid decrement $5, giving a new target bid of $65.

The ‘traffic light’ bidder position indicator therefore gives Supplier 1 a green light for this auction, in accordance with the bidder's leading position, whilst Suppliers 2 and 3 are provided with red lights indicating that each needs to submit a counterbid in accordance with their indicated target bid in order to lead the auction under Option 1.

### Option 2

Turning now to the two subcontract awards to be conducted as two sub-auction bidding events, Suppliers 4-9 are each allocated trade-off penalties (of $5, 0, $10, $5, 0 and $10 respectively), to be applied to bids received before comparison with other bids in their respective auction events. It is to be note that the penalties (as well as the minimum bid decrement) are calculated to reflect the relatively lower size of the lots at stake in each auction.

The system therefore applies these penalties to their starting bids, to give factored bids of $45, $47, $49, $40, $38 and $43 respectively, as shown. Suppliers 4 and 8 thus hold the leading positions at the start of their respective sub-auction bidding events, and target bids for the counterparties are therefore calculated relative the bids of Suppliers 4 and 8.

Thus, Supplier 5's target bid is calculated by the system as $45 (the leading factored bid in that event), minus zero penalty (as Supplier 5 has a 0 penalty trade-off), minus the minimum bid decrement $2.5, which gives a target bid of $42.5. Similarly, the target bid for Supplier 9's target bid (for example) is calculated by the system as $38 (the leading factored bid in that event), minus $10 penalty (as Supplier 9 has a $10 penalty trade-off), minus the minimum bid decrement $2.5, which gives a target bid of $25.5.

Green traffic light signals therefore provide to Suppliers 4 and 8 an indication of their leading bid status in their respective event, whilst the other parties are provided with red lights indicating that each needs to submit a counterbid in accordance with their indicated target bid in order to lead the respective event. However, this gives only part of the story. The combined factored bids of leading Suppliers 4 and 8 is $38 plus $45, i.e. $83, which trails the leading factored bid under Option 1 by $3. When the option trade-off penalty is applied, then Option 1 leads Option 2 by $8 under the factored comparison basis, and Suppliers 4 and 8 will not win the awards of the respective subcontracts in the overall auction event.

The system approaches this problem by providing to each bidding party a second target, representing the target bid that that party needs to submit to ensure that their option is the leading one. In the example of FIG. 3, since Option 1 is the leading option, this is the same target for all suppliers as the target bids provided for those suppliers to win the particular sub-auction event in which they are competing. But this is not the case for those suppliers bidding under Option 2.

For Suppliers 4, 5 and 6, a factored option target bid is first calculated by taking the leading factored bid from the other option Option 1 (i.e. $80), applying the option trade-off penalty ($5), and subtracting the leading factored bid from the other sub-auction bidding event (or a sum of all such leading factored bids of other sub-auction bidding events running under the same option, if more than one), being $38 in this case, giving a factored option target of $37. This is, of course, the same for all counterparties competing in an event, since it represents a measure of how that event must perform in order to compete in the overall auction event.

The actual bidding party target option bids are then calculated by the system as before. For Supplier 6, for example, the target bid is $37 (the calculated factored option target bid in that event), minus $10 penalty (as Supplier 6 has a $10 penalty trade-off), minus the minimum bid decrement $2.5, which gives an option target bid of $24.5.

Similarly, for Suppliers 7, 8 and 9, a factored option target bid is first calculated by taking the leading factored bid from the other option, Option 1 (i.e. $80), applying the option trade-off penalty ($5), and subtracting the leading factored bid from the other sub-auction bidding event (or a sum of all such leading factored bids of other sub-auction bidding events running under the same option, if more than one), being $45 in this case, giving a factored option target of $30.

For Supplier 7, for example, the option target bid is then calculated as $30 (the calculated factored option target bid in that event), minus $5 penalty (as Supplier 7 has a $5 penalty trade-off), minus the minimum bid decrement $2.5, which gives an option target bid of $22.5.

Each supplier is therefore provided with a second target bid, an ‘option target bid’. This represents the bid that that party must submit in order that the option in which that party if involved is the leading option. Again, traffic light signals (which will be the same color for all bidders in an option) are used to indicate whether that supplier's option is presently the leading option or not. In this case, all traffic lights under Option 2 are red, as Option 1 is the leading option.

In many situations, particularly at the start of or in the early parts of an auction event, the option target bid may represent a very onerous target for a bidding party, particularly if the other sub-auction event(s) is/are not running in a competitive manner. In other words, if bidders are not ‘pulling their weight’ with respect to a particular subcontract, then bidders in respect of the other subcontract(s) under that option will need to bid more aggressively to ‘carry’ the other auctions in order to ensure their particular option remains competitive.

To deal with such auction dynamics, in the case of auction event options including subcontracts, a further target bid is provided to each bidding party, representing the bid that that party must make in order to contribute fairly to the success of that option. This is calculated simply by applying the option trade-off to the leading factored bid from the other option, Option 1, to give $75. The contribution weightings (of 0.5 in each case) are then applied to this factored bid to give a factored contribution target for all bidding parties under Option 2 of $37.5.

The actual bidding party contribution target bids are then calculated by the system as before. For Supplier 6, for example, the contribution target bid is $37.5 (the calculated factored contribution target bid in that event), minus $10 penalty (as Supplier 6 has a $10 penalty trade-off), minus the minimum bid decrement $2.5, which gives an option target bid of $25. Similarly, for Supplier 8, for example, the contribution target bid is $37.5 (the calculated factored contribution target bid in that event), minus zero penalty (as Supplier 8 has a $0 penalty trade-off), minus the minimum bid decrement $2.5, which gives an option target bid of $35. This provides an indication to a bidding party of where they need to aim in order to be providing a fair contribution to the chances of success of the option in which they are involved.

Once again, traffic light signals are used to indicate to a bidding party whether or not that supplier is presently making a sufficient contribution to the particular option in which they are involved. In this case, all traffic lights under Option 2 are red, as none of the bidding parties under that option is yet contributing sufficiently to this option.

The auction event is then commenced, and the bidding parties bid downwardly against one another in an attempt to secure both the success of their bid, and the success of the option in which they are involved. As new bids are submitted and received by the facilitator computer, the calculations described above are carried out to provide all bidding parties with dynamic information regarding their position in the respective auction events. The three target bids presented to a bidding party provide a real time indication as to how that bidding party must adjust his bidding behavior in the light of progress not just of the sub-auction bidding event in which he is involved, but also in the light of progress of the other events that are involved in the option in which he is bidding. At the same time, the approach provides to the controlling party a mechanism for automatically optimizing the decision-making process in a real time auction event.

The method and system of the invention thus provides a very powerful tool in driving bidder performance, even in potentially very complex multi-option events, whilst ensuring that the transparency of the overall event if maintained, and that the event will conclude with the award of the contract.

The dynamics of the progress of this event are clearly likely to be complex, but the method of the invention enables all of the calculation to be carried out by the facilitator computer, the suppliers being provided with only the information needed to inform their real time decision-making Clearly, for a supplier, the winning of the individual auction and of the option in which that supplier is involved are both critical issues, and each supplier is furnished with a continuing indication of how to adjust their bid to maximize their chances of being the leading bid in both respects.

The simplest example of an auction employing the method of the invention would involve two options, with a single auction running under each option. In this case, the contribution for each supplier is 1.0. Clearly, the concept of the present invention can be extended to any desired number of options, with any number of contributory auctions conducted under each option.

The present invention may be applied to the procurement process for any goods or services which are sufficiently valuable (to justify use of the process), specifiable (so that competing suppliers are able to interpret the requirements, and to afford a consumer basis for comparison), and contestable (i.e. more than one supplier has the capability to fulfill the request).

In addition, the invention may be applied to the selling of goods, services or assets. It may, for example, be applied to the selling of telecommunications spectrum, or to IPOs or rights issues.

In a forward auction scenario, the bidding party factors may represent a loyalty, rebate or discount arrangement, or may represent a cost to the seller, built in to the lot price. By way of simple example, if the auction event relates to the ‘as-delivered’ selling price of a lot of timber to a buyer or buyers selected from a panel of different wood mills, then the buyer factors applied may be determined in accordance with the distance (and any associated delivery obstacles) of the buyers from the felling location. If, for example, Buyer 1 is allocated a $10 penalty relative to Buyer 2, because of the additional distance between the felling location and the location of Buyer 1's mill, then in factoring a bid from Buyer 1 an amount of $10 is deducted from the received bid before comparison with a bid received from Buyer 2. If, for example, Buyer 2 then holds the leading factored bid LFB, and the minimum bid increment is set at $5, then Buyer 1's target bid for that auction will be calculated as LFB+$10+$5.

### Detailed Example of Multi-Option Auction System and Process

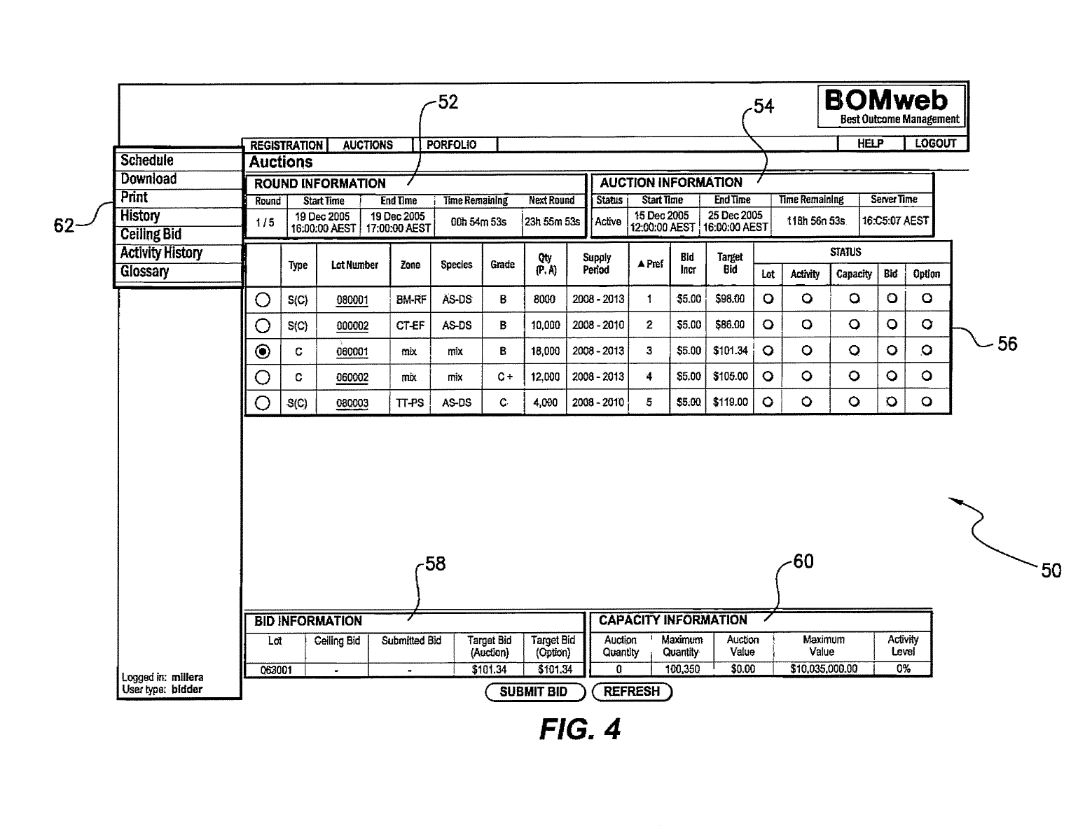

An embodiment of an online forward-type auction system and process according to the present invention has been developed and tested by the present applicant for the sale of timber from a forestry body (the controlling party) to a plurality of mills (the panel of bidding parties). FIG. 4 shows an example of the Auctions page that appears to a registered bidder during the auction event.

Under the rules of this system and process, in preparing for an auction event, qualified bidders are able to create combination lots, i.e. combinations of single timber lots for which they are interested in bidding. These combination lots are then added to the suite of lots available for registration during the registration period. In the auction event, all lots, including combination lots, are put up for bidding simultaneously, and bidders have the opportunity to submit bids on all lots and combinations for which they are registered. Under control of the system algorithms, and in accordance with the rules of the system, lots are then contested (i.e. bids are compared) both as single lots, and as part of larger combination lots, simultaneously. Since the system provides that a lot can be awarded to a bidder either as a single lot or as part of a combination lot, this gives rise to more than one option for award of the lot.

For example, if a single lot is part of only one combination there are 2 options for awarding that lot, either as a single lot (Option 1) or as part of the combination lot containing it (Option 2). If a single lot is involved in two combination lots we have 3 options for awarding the lot. It can be awarded as a single lot (Option 1), as part of the first combination lot (Option 2), or as part of the second combination lot (Option 3).

It will be noted that when a combination lot is created, it can give rise to the generation of more than one new auction option. This occurs when a combination lot consists of at least one single lot that is shared with another combination lot. When lots ‘overlap’ in this way, multiple options are generated each time a new combination lot is created using one or more of those lots. So, for example, there may be only 10 combination lots in a particular auction, but if all 10 combination lots have overlapping single lots contained within, there could be thousands of options generated by the system, all of which will become a competing option during the auction event. Every time a bid is placed the system therefore recalculates a new TBO (Target Bid [Option]) for each bidder for every lot and every option that involves overlapping lots.

It will be appreciated that, in such situations, the controlling party is not directly setting up the different options; they are instead automatically generated by the system during the registration process for the auction event as the prospective bidders reserve their rights to bid for the respective lots and combinations of lots.

It is important to note that, no matter the number of options in which a lot is involved, that lot will always be awarded to the option that offers the highest return to the controlling party (the vendor). In accordance with the invention, during the auction a bidder is able to tell whether their option is leading the bidding by looking at the ‘Option Status’ column on the auctions page.

During the event, the TBA (Target Bid [Auction]) indicates to a bidder the minimum mill door price that bidder must bid in order to record a valid bid in the system and lead the auction for that lot. The TBO (Target Bid [Option]) indicates to a bidder the minimum mill door price that bidder must bid to become the lead bidder and to make that option the leading option. It will be understood, then, that the TBO and the TBA can be the same amount or can be different amounts. When the targets are the same, making the bid not only means that the bidder will become the lead bidder for that lot, but also that that bidder's option will be leading. If no valid counterbid is received (for that lot or for a combination that contains it), then that bidder will therefore be awarded that lot.

It will be realized that it is possible to be the lead bidder for a lot, and still not win that lot. If a bidder's TBA is lower than the TBO, and the bidder submits a bid at the TBA amount, that bidder will then be leading the bidding for that lot, but that bidder's option will not be the leading option. This means that, if no bids are made on other lots that are part of that particular option, and the bidder does not make another bid on that lot, the bidder could lose the lot to another option.

Taking the example of a first bidder bidding on a single lot (Lot A), which is also part of a combination lot on which that bidder is not bidding. The first bidder sees that he has been outbid by another bidder, and decides to make a new bid. He clicks the radio button for the lot and sees on his Bid Information Panel that his TBA (Target Bid [Auction]) is $87.00 and his TBO (Target Bid [Option]) is $95.00. If he chooses to bid $87.00, he will be the lead bidder for that lot, but his option will not be the leading option. Assuming that he does not change his bid, if no one bids on any of the other single lots that are part of the same combination lot, the first bidder will not win Lot A. If a second bidder submits a bid on one of the other single lots that are part of the same combination lot, this could impact on the process to make the first bidder's option the leading option, and thus the first bidder could win Lot A. It will be appreciated that in this way the single lots must ‘work together’ against the combination lot.

Of course, if the first bidder chooses to bid $95.00 for Lot A, he will be leading both the auction and the option. If no one bids against him, he will be awarded the lot at the end of the round.

The bidder's auction page 50 in FIG. 4 includes the following information:

Round Information —52—this tells bidder the Round (i.e. the auction event) currently in progress, the start and end time for the current Round, the time remaining for the Round, and the length of time until the next Round begins.

Auction Information —54—this includes Auction Status (Active, Paused, Closed), the start and end dates and times for the Auction, the time remaining for the Auction, and the Server Time.

Lot Information —56—this gives the following additional information for all the Lots for which the bidder is registered:

Lot Selection radio button—this allows the bidder to select a Lot for information or for bidding, changing the Bid Information (see below) to display the information for the selected Lot. As the figure shows, information about each lot is displayed in a plurality of fields, including lot number, timber species and grade, quantity, supply period, etc. The ‘type’ information indicates whether a particular lot is a single lot (S) or a combination lot (C), or a single lot that is also part of a combination lot (S(C)). The bidder can selectively sort the list of lots by each field.

Bid Incr (Bid Increment)—this shows the bid increment for each Lot for the current Round in the Active period, and the next Round in the Paused period

Lot Status—this provides the bidder with information pertaining to the Lot using color codes (or ‘traffic lights’), important for providing continuous feedback to the bidder as to whether or not he is the lead bidder in an auction for that Lot, and whether the Option in which that Lot features is the leading Options. For example, a green Bid Status indicates that the bidder is the lead bidder in the Auction for the selected Lot, whilst a red Bid Status indicates that he is not. A green Option Status indicates that the Lot is part of the Option that is leading the bidding, whilst a red Option Status indicates that it is not. An Option Status is Blank for a bidder when there is no Option to compete against and the only way to be the successful bidder on the Lot is to bid on the Single Lot alone (i.e. the Lot is not part of any Combination Lot). A grey Option Status indicates that a Lot is part of more than one Option, but there has been no bidding activity yet on any Option with which the Lot is involved.

Activity Status—this gives the bidder information regarding his Activity with regard to that Lot, also using color codes.

Capacity Status—this gives the bidder information regarding his capacity to make a bid on that Lot, also using color codes.

Bid Status—this gives the bidder information as to whether or not he is leading the bidding for that Lot, also using color codes

Option Status—This gives the information as to whether or not the Lot is the lead option, also using color codes.

Bid Information —58—This provides the bidder with Lot-specific information, selected by way of the radio buttons. In this case, the Bid Information shown for a particular Lot is a weighted average ‘mill door price’ value. Bid Information includes the following:

Lot Number

Ceiling Bid—as set by the bidder during Registration or as updated during the Auction event.

Submitted Bid—the last bid (if any) that the bidder submitted for that Lot.

Target Bid (Auction)—the bidder's Target Bid for the Auction, i.e. the next Target Bid the bidder must submit in order to lead the Auction.

Target Bid (Options)—the bidder's Target Bid for the Option, i.e. the next Target Bid the bidder must submit in order to put that Option in the lead.

Capacity Information —60—this shows the bidder the total quantity of timber for the Lots in which he is currently the lead bidder, plus those which he has already won, the maximum quantity per year he may win during the Auction, the total value of the Lots for which he is currently the lead bidder plus those which he has won, the maximum timber value he may win during the Auction, and his Activity Level. The Activity Level is the amount of timber—in cubic meters gross—on which he has been actively bidding during the current Round.

FIG. 4 also shows on the left hand side of the Auctions page the Auction Command Panel 62, which allows the bidder to take actions such as reviewing schedules, reviewing bid histories, printing screens, adjusting floor or ceiling bids, etc.

The skilled reader will appreciate that the present invention allows extremely complex multiple option auction events to be conducted in real time, even though an event may involve hundreds of thousands of different options to be compared virtually simultaneously. This is possible because, in order to calculate a leading option, the present invention does not require new calculations to be performed for every potential bid for a particular lot, Instead, the present invention involves only the processing of potentially winning bids (those that meet or exceed a party's current target bid) in order to provide to bidders the target bid required in order for the relevant option to become the winning option. In contrast, conventional approaches to combinatorial auctions have always been iterative, in which the results of one bidding round are published to the participating bidders, in order to inform bidder inputs for the next round.

Some practical examples of such types of combination scenario include contracting for transport services (a reverse-type auction), in which bidders combine certain routes to suit their businesses, packaging (a reverse-type auction process), in which bidders combine certain package types or locations that suit their businesses, and timber sales (a forward-type auction), in which bidders can specify to combine certain types of timber product, e.g. species, grade, location, etc.

It will also be appreciated that a variety of options in an auction event may represent a variety of volume combinations to arrive at a required overall lot on which the auction is conducted. By way of example, an organization may choose to run a procurement auction for 20,000 tonnes of a particular supply and to put out an RFT to a panel of suppliers, who may have the following respective capacities.

TABLE 5

| Suppliers 1, 2, 3 | 5,000 T |
|---|---|
| Suppliers 4, 5 | 10,000 T |
| Suppliers 6, 7 | 20,000 |

Clearly, the RFT can be satisfied in any one of a number of ways, such as a single lot of 20,000 T, or a combination of smaller lots of the same or differing volumes. Bidder 6, for example, by virtue of economy of scale, is ideally placed to bid for a single lot of 20,000 T. However, bidder 6 may also wish to bid on smaller volume lots. The following table shows the four different options that may be generated for conducting the auction, and how which bidders may wish to register for which options.

TABLE 6

| | Volume | Potential |
|---|---|---|
| Option | combination | bidders |
| 1 | 20,000 T | 6, 7 |
| 2 | 10,000 T x 2 | 4, 5, 6, 7 |
| 3 | 5,000 T x 4 | 1, 2, 3, 4, 5, 6, 7 |
| 4 | 5,000 T x 2 + 10,000 T | 1, 2, 3, 4, 5, 6, 7 |

During the auction, as already described in detail, each bidder registered for each option will receive bid guidance (by way of Target Bid (auction) and Target Bid (option) and, preferably, also bid status (by way of the traffic light indicators indicating whether that bidder's bid is the leading bid, and whether that bidder's bid in is the leading option.

Some practical examples of such types of scenario include commodity sourcing with multiple volume allocation options (a reverse-type auction), and ‘adword’ allocation (a forward-type auction), for allocating advertisement space on online pages in response to search queries, in which the ‘volume’ can represent the number of search submissions.

It will further be appreciated by the skilled reader that a number of further factors may come into consideration in generating different options in different auction scenarios and for particular types of event. One such factor is the term of a supply agreement, and the problem of optimally allocating a contract that can have be satisfied by a variety of different supply terms. The following table illustrates a situation in which the contract can be awarded as a 1, 2, 3 or 4 year contract, giving rise to options O1-O4. During the event, to calculate the Target Bid (option), all possible options are created (in this case four options each for the respective different contract term) the leading option is calculated (in this case, in a forward auction, the leading option is O3 at 120, giving a 3 year optimum contract term), and the auction system then calculates the lowest Target Bid (option) for each lot in every other option to match the leading option, factoring by way of option factors and bidder factors. Clearly, such situations can give rise to the need to specific rules dictating mutually exclusive lots for particular bidders.

TABLE 7

| | Term | | | | |
|---|---|---|---|---|---|
| | (years) | O1 | O2 | O3 | O4 |
| Lot 1 | 1 | 1 | 0 | 0 | 0 |
| Lot 2 | 2 | 0 | 1 | 0 | 0 |
| Lot 3 | 3 | 0 | 0 | 1 | 0 |
| Lot 4 | 4 | 0 | 0 | 0 | 1 |
| Total | | 100 | 110 | 120 | 110 |

Some practical examples of such types of scenario include electricity sourcing (a reverse-type auction), in which each supplier might have a different forward cost curve and a different cost relevant to different contract terms, and timber sales (a forward-type auction), in which several supply period options may be possible.

As a further variant, it may be necessary to allocate a number of lots to a number of bidders, where the controlling party determines limits on the number of bidders that may win the available lots (e.g. for reasons of risk management). The following table illustrates such an auction scenario, in which there are four lots and four bidders, and no bidder is permitted to win more than one lot.

TABLE 8

| | Slots | O1 | O2 | O3 | O4 | O5 |
|---|---|---|---|---|---|---|
| Lot 1 | 1 | 1 | 4 | 3 | 2 | 4 |
| Lot 2 | 2 | 2 | 1 | 4 | 3 | 3 |
| Lot 3 | 3 | 3 | 2 | 1 | 4 | 2 |
| Lot 4 | 4 | 4 | 3 | 2 | 1 | 1 |
| Total | | 100 | 90 | 120 | 110 | 105 |

In such a situation, the system creates all of the possible options, in accordance with prescribed rules reflecting the constraints set. In the example, the leading option O3 at 120 corresponds to bidder 3 leading on lot 1, bidder 4 leading on lot 2, bidder 1 leading on lot 3, and bidder 2 leading on 4. The system then calculates the lowest Target Bid (option) for each lot in every other option to match the leading option, factoring with reference to set option factors and bidder factors.

Practical examples of such types of scenario include commodity sourcing (a reverse-type auction), in which risk considerations might require at least two suppliers to be involved in the winning contract, and other considerations set a maximum limit of four winning suppliers in the winning contract. A practical example of a forward-type auction is an ‘adword’ allocation auction, in which each lot represents a keyword search slot position (a sponsored link), and each bidder can win only one position.

As yet a further variant, an implementation of the present invention may involve the provision of additional Target Bids during the online auction event, depending on the particular application. For example, in an ‘adword’ allocation auction, in which bidders bid for placement in online advertising slots provided by search engines on search results pages. The highest bid wins the number one slot, second highest bid the second slot, and so on. As each keyword can be allocated to multiple slots, in accordance with the present invention the auction process is designed to optimally combine allocations to maximize revenue to the controlling party (the search engine provider).

The following tables illustrate such an auction between three bidders competing for Keyword 1 in three slots, table 9 showing initial (factored) bids from the bidders, and table 10 showing slot allocations, giving rise to 6 different ‘slot options’ SO1-SO6.

TABLE 9

| | Bidder | Bidder | Bidder |
|---|---|---|---|
| Keyword 1 | 1 | 2 | 3 |
| Slot 1 | $100 | $92 | $88 |
| Slot 2 | $95 | $90 | $86 |
| Slot 3 | $91 | $85 | $80 |

TABLE 10

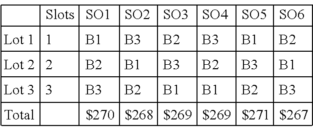

It will be noted that as the number of bidders and slots the number of options rises exponentially, for example 10 bidders competing for 5 slots gives rise to some 30,000 different slot options.

A Target Bid (Lot) can be provided for each bidder, to guide each party as to how they may bid to lead the lot, and this may incorporate a quality index based on click-through rate to factor each bidder for each slot.

In this example, the leading option is SO5 at $271, meaning that (if the auction were to end at this point) Bidder would win Lot 2, Bidder 1 Lot 1, and Bidder 2 Lot 3. The system then calculates the lowest Target Bid (Option) for each lot in every other option based on this leading option.

The auction system must also be configured to consider the further combination dimension of multiple keywords available for bidding. Such a scenario gives rise to the problem of optimally combining keywords to maximize revenue for the controlling party. This is achieved by two stages of comparison between different potential outcomes, first at the keyword level for each slot, and then at the combination level for each combination of keywords, in order to resolve the best optimized overall combination. The following table illustrates a set of keyword options associated with 3 different keywords 1-3, which gives rise to five different keyword options WO1-WO5.

TABLE 11

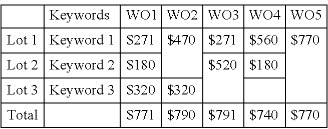

The light cross shading in the table indicates keyword combinations, e.g. WO1 indicates a combination of three single bids; option WO3 indicates a combination of one bidder's bid of $520 for a combination of Lots 2 and 3 (Keyword 2 and Keyword 3), plus a bidder's bid of $271 for single Lot 1 (Keyword 1); whilst WO5 indicates a one bidder's bid for a combination of all three lots (Keyword 1 and Keyword 2 and Keyword 3).

The leading option is calculated by the system (in this example, WO3 at $791), which then calculates Target Bid (Option) for each lot in every other option. The system will thus create multiple option targets for each lot, because each lot is included in each option. It will be noted that the leading bid for the slot allocation event for Keyword 1 from Table 10 features in Table 11 for combinations that involve single lots for Keyword 1 (i.e. WO1 and WO3. Thus, the leading Keyword option is WO3, meaning that slot option SO5 is part of a leading option.

The result is the provision to each bidder of three target bids, a target bid for each lot (Target Bid (Lot)), a target bid for each slot option Target Bid (Slot Option)) and a target bid for each keyword (Target Bid (Word Option)). The following table illustrates an example bidder screen (for Bidder 2) including option two target bids, and for simplicity it is assumed that Bidder 2 is only bidding on Keyword 1.

TABLE 12

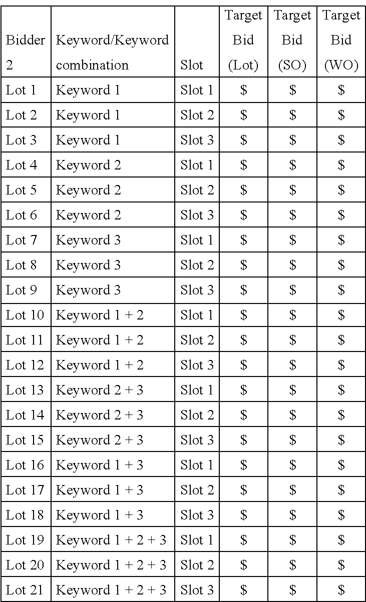

The green traffic lights (hashed shading in the boxes of Table 12) indicate to Bidder 2 that that bidder is leading for Lot 3, being Keyword 1 in Slot 3 (as part of a combination option, as Table 10 shows), and is part of a leading word combination (as Table 11 shows), in combination with the lots that combine Keywords 1 and 2, i.e. Lots 13, 14, 15. It will be noted that, as Table 9 clearly indicates, Bidder 2 is not leading in any one Lot (and thus does not receive any green traffic lights with regard to each Lot per se), but by virtue of the different slot and keyword combinations Bidder 2 is part of a leading combination and, if the auction were decided at this point, would receive an allocation of Slot 3 for the keyword (Keyword 1) of interest. Thus, the auction system automatically operates to arrive at a selection—from multiple sub-auction events and multiple options—an outcome providing the best overall value (in this case, revenue) for the controlling party.

It will be understood that further combination dimensions could also be considered, giving rise to further option target bids, such as location combinations (Target Bid (Location Option)), demographic combinations (Target Bid (Demographic Option)), and search volume combinations (Target Bid (Volume Option)).

The word ‘comprising’ and forms of the word ‘comprising’ as used in this description and in the claims does not limit the invention claimed to exclude any variants or additions. Modifications and improvements to the invention will be readily apparent to those skilled in the art. Such modifications and improvements are intended to be within the scope of this invention.

1. A method for communicating data over a network to automatically conduct an electronic online auction with multiple simultaneous transactions, the method comprising:
using a computer network including at least two bidding computers and at least one administrator computer communicating over the Internet or other communication network;
storing data, in a database of at least one of the administrator computer or the bidding computers, data relating to at least two alternative contract options of the online auction, one or more of said alternative contract options having a corresponding plurality of different lots, each lot being the subject of a subcontract, which together combine to provide the contract;
providing computer readable mediums for online access by at least two bidding computers and at least one administrator computer, the mediums comprising instructions to conduct the online auction with the multiple simultaneous transactions to include determining whether two alternative contract options are potentially acceptable to a controlling party;
automatically conducting the online auction by the exchange of electronic data between a controlling party operating the administrator computer, and at least two parties from a prescribed panel of qualified competing bidding parties, each competing bidding party operating a respective bidding computer, the conducting step further comprising receiving data by the at least one administrator computer regarding at least one bid transmitted over the network from respective bidding computers;
the computer readable mediums further having instructions that (i) automatically compare, during the online auction event, data reflective of respective bids and respective contract options involving those bids; (ii) select from the alternative contract options to award the contract on the basis of the comparisons, (iii) automatically conduct sub-auction bidding events wherein at least one of the alternative contract options includes data reflective of two or more subcontracts, each subcontract awarded in a corresponding sub-auction bidding event for a lot, each sub-auction bidding event therefore being an electronic competitive bid for a lot comprised in the contract; (iv) automatically allocate, by or on behalf of the controlling party, data reflective of respective bidding party factors to the competing bidding parties, each factor applied to bids received from a respective party's bidding computer before comparison with any other bid in a sub-auction bidding event; (v) automatically conduct all the sub-auction bidding events simultaneously and applying the respective bidding party factors to bids received from said bidding computers for comparison during the auction event between the different bids and between the different options; (vi) during the online auction event, automatically providing each bidding computer of parties involved in a sub-auction bidding event for the related lot data reflective of an option target bid (OTB) indicating a bid that that a party must make for that lot to ensure the option in which that sub-auction bidding event is involved is a leading option in the auction event; (vii) during the online auction event, automatically creating data reflective of a lot target bid (LTB) for each party and transmitting the respective LTB to each bidding computer of parties involved in a sub-auction bidding event, the LTB indicating an electronic bid that that party must make to be a leading bid in the corresponding sub-auction bidding event; and
wherein the computer readable mediums automatically generate an electronic output to cause an indication of a corresponding OTB and LTB from a corresponding sub-auction bidding event to be displayed on a corresponding screen display of at least one bidding party's computer.

2. The method of claim 1, further including the steps of:
automatically allocating, by or on behalf of the controlling party, respective option factors to said contract options, each option factor applied to calculations with respect to the associated contract option before comparison with any other contract option;
during the online auction event, automatically applying said respective option factors to bids received from said bidding computers for comparison during the auction event between the different bids and between the different options; and
automatically generating a revised output display taking into consideration the application of the option factors.

3. The method as claimed in claim 1, wherein the comparison between different contract options is carried out by automatically comparing leading factored bids, and/or leading combinations of factored bids in the respective sub-auction bidding events, between the different options.

4. The method as claimed in claim 1, wherein said OTB is calculated by the steps of:
automatically comparing the competing contract options;
automatically establishing, in accordance with that comparison, a bid or bid combination representing a leading option in the auction event; and
automatically calculating, on the basis of that leading option, an option target bid for each bidding party involved in other sub-auction bidding events by applying the bidding party factors and a minimum bid increment or decrement.

5. The method of claim 1, further including:
automatically allocating respective option factors to said contract options, each option factor applied to calculations with respect to a contract option before comparison with other contract options;
wherein said respective option factors are also used to calculate, on the basis of said leading option, the OTB for each bidding party involved in said other sub-auction bidding events; and
automatically generating a revised output display taking into consideration the application of the option factors.

6. The method of claim 1, wherein said LTB is automatically calculated by the steps of:
automatically comparing, in a sub-auction bidding event, received bids from the competing bidding parties to which bids said bidding party factors have been applied;
automatically establishing, in accordance with that comparison, a leading bid in that sub-auction bidding event; and
automatically applying the bidding party factors and a minimum bid increment or decrement to said leading bid to arrive at a target bid for each bidding party in that sub-auction bidding event.

7. The method as claimed in claim 1, further including the steps of:
automatically specifying, by or on behalf of said controlling party, a contribution weighting for each subcontract relative to the overall contract of that contract option; and
during the online auction, automatically providing to each bidding computer of the competing bidding parties in a sub-auction event involved in that contract option, a contribution target bid (CTB) indicating a bid that that party must make to satisfy a contribution threshold for that option.

8. The method of claim 7, wherein said CTB is calculated by the steps of:
automatically comparing competing contract options;
automatically establishing, in accordance with that comparison, a bid or bid combination representing a leading option in the auction event; and
automatically calculating, on the basis of that leading option, a contribution target bid for each bidding party involved in other sub-auction bidding events by applying the contribution weighting, the bidding party factors and a minimum bid increment or decrement.

9. The method of claim 8, wherein said respective option factors are also used to calculate, on the basis of the leading option, a CTB for bidding parties involved in said other sub-auction bidding event.

10. The method as claimed in claim 1, wherein the event is a reverse-type auction, said controlling party is a buyer and said competing bidding parties are sellers.

11. The method as claimed in claim 1, wherein the event is a forward-type auction, said controlling party is a seller and said competing bidding parties are buyers.

12. The method as claimed in claim 1, wherein, during the auction event, each target bid provided to each bidding computer is automatically accompanied with an indicator to indicate whether or not that bidder presently holds the leading bid in respect of that target.

13. The method of claim 12, wherein, during the auction event, each target bid provided to each bidding computer is automatically accompanied with an indicator to indicate whether or not that bidder presently holds a bid in a leading option.

14. The method as claimed in claim 1, wherein the auction relates to a contract for a defined quantity of product(s), service(s) or resource(s), and the alternative contract options involve at least one combination of smaller quantities of said product(s) or service(s) making up said defined quantity.

15. The method as claimed in claim 1, wherein the administrator computer is an auction administrator computer, the auction administrator computer automatically applying said respective factors with respect to bids received from said bidding computers and automatically making the comparisons during the auction event between the different bids received and between the different options.

16. A system for communicating data over a network to automatically conduct an electronic online auction with multiple simultaneous transactions, the system including:
at least one administrator computer communicating with at least two bidding computers over the Internet or other computer network;
the system automatically conducting the online auction event between a controlling party and at least two parties from a prescribed panel of qualified competing bidding parties, each competing bidding party operating a respective bidding computer, the online auction including data in the form of at least two alternative contract options potentially acceptable to said controlling party, one or more of said alternative contract options having a corresponding plurality of different lots, each lot being the subject of a subcontract, which together combine to provide the contract, the system including a computer readable medium for online access by each of the computers for automatically conducting and managing the online auction, the computer readable mediums including instructions to receive bids from respective bidding computers, instructions for automatically comparing, during the online auction event, the respective bids and the respective contract options involving those bids, and instructions for automatically selecting from said alternative contract options and for providing automatic notification regarding award of the contract on the basis of the comparisons, wherein at least one of said alternative contract options involves two or more subcontracts, each subcontract able to be selectively and automatically awarded in a sub-auction bidding event for a lot, each sub-auction bidding event therefore being a competition for a lot comprised in the contract, the system further including:
the computer readable medium having instructions for selectively and automatically allocating, by or on behalf of the controlling party, respective bidding party factors to said competing bidding parties, each factor to be applied to bids received from the respective party's bidding computer before comparison with any other bid in a sub-auction bidding event;
the computer readable medium further having instructions for automatically conducting the online auction by conducting all the sub-auction bidding events simultaneously and applying said respective bidding party factors to bids received from said bidding computers for comparison during the auction event between the different bids and between the different options;
the computer readable medium further having instructions for, during the online auction event, automatically providing to each bidding computer of parties involved in a sub-auction bidding event for the related lot an option target bid (OTB) display of a bid that that a party must make for that lot to ensure the option in which that sub-auction bidding event is involved is a leading option in the auction event; and
the computer readable medium further having instructions for, during the online auction event, providing to each bidding computer of parties involved in a sub-auction bidding event a lot target bid (LTB) display of a bid that that party must make to be the leading bid in that sub-auction bidding event; and
the computer readable medium further having instructions for automatically generating an output in the form of at least one output on a screen display of one of the computers, the output including an indication of a corresponding OTB and LTB from a corresponding sub-auction bidding event.

17. The system of claim 16, wherein the computer readable medium further includes instructions for automatically generating respective option factors to said contract options, each option factor applied to calculations with respect to the associated contract option before comparison with any other contract option, and instructions for, during the online auction event, to selectively and automatically apply said respective option factors to bids received from said bidding computers for automatic comparison during the auction event between the different bids and between the different options.

18. The system of claim 16, wherein the computer readable medium further has instructions for automatically carrying out the comparison between different contract options by comparing leading factored bids, and/or leading combinations of factored bids in the respective sub-auction bidding events, between the different options.

19. The system of claim 16, wherein the computer readable medium further has instructions for automatically creating a logical calculation unit for calculating said OTB, in which the instructions further comprise:
automatically comparing competing contract options;
automatically establishing, in accordance with that comparison, a bid or bid combination representing a leading option in the auction event; and
automatically calculating, on the basis of that leading option, an option target bid for each bidding party involved in other sub-auction bidding events by automatically applying the bidding party factors and a minimum bid increment or decrement.

20. The system of claim 19, wherein the computer readable medium further has instructions for automatically allocating respective option factors to said contract options, each option factor to being automatically applied to calculations with respect to a contract option before comparison with other contract options; and
wherein said respective option factors are also used to automatically calculate, on the basis of said leading option, the OTB for bidding parties involved in said other sub-auction bidding events.

21. The system of claim 19, wherein the computer readable medium further has instructions for automatically calculating said LTB, in which the instructions further comprise:
automatically comparing, in a sub-auction bidding event, received bids from the competing bidding parties to which bids said bidding party factors have been applied;
automatically establishing, in accordance with that comparison, a leading bid in that sub-auction bidding event; and
automatically applying the bidding party factors and a minimum bid increment or decrement to said leading bid to arrive at a target bid for each bidding party in that sub-auction bidding event.

22. The system of claim 19, wherein the computer readable medium further comprises:
instructions for automatically specifying a contribution weighting for each subcontract relative to the overall contract of that contract option; and
instructions for, during the online auction, automatically providing to each bidding computer of the competing bidding parties in a sub-auction event involved in that contract option, a contribution target bid (CTB) indicating a bid that that party must make to satisfy a contribution threshold for that option.

23. The system of claim 22, wherein the computer readable medium further comprises: instructions for automatically calculating said CTB by automatically comparing competing contract options, automatically establishing, in accordance with that comparison, a bid or bid combination representing a leading option in the auction event; and automatically calculating, on the basis of that leading option, a contribution target bid for each bidding party involved in other sub-auction bidding events by applying the contribution weighting, the bidding party factors and a minimum bid increment or decrement.

24. The system of claim 19, wherein the computer readable medium instructions further include instructions for automatically providing to each bidding computer, during the auction event, a display showing an indicator whether a selected bidder presently holds a leading bid in respect of a target bid.

25. The system of claim 24, wherein the computer readable medium instructions further include instructions for automatically providing to each bidding computer, during the auction event, a display showing an indicator whether a selected bidder presently holds a bid in a leading option.

25. The system of claim 19, further including:
an auction administrator computer connected by the computer network to said bidding computers, wherein the computer readable medium instructions further include instructions for the auction administrator computer to automatically apply said respective factors with respect to bids received from said bidding computers and make the automatic comparisons during the auction between the different bids received and between the different options.

26. A method for communicating data over a network to automatically conduct an electronic online auction with multiple simultaneous transactions, the method comprising:
using a computer network including at least two bidding computers and at least one administrator computer communicating over the Internet or other communication network;
storing data, in a database of at least one of the administrator computer or the bidding computers, data relating to at least two alternative contract options of the online auction, one or more of said alternative contract options having a corresponding plurality of different lots, each lot being the subject of a subcontract, which together combine to provide the contract;
providing a computer readable medium for online access by at least two bidding computers and at least one administrator computer, the medium comprising instructions to automatically conduct the online auction with the multiple simultaneous transactions to include determining whether two alternative contract options are potentially acceptable to a controlling party;
automatically conducting the online auction by the exchange of electronic data between a controlling party operating the administrator computer, and at least two parties from a prescribed panel of qualified competing bidding parties, each competing bidding party operating a respective bidding computer, the conducting step further comprising receiving data by the at least one administrator computer regarding at least one bid transmitted over the network from respective bidding computers;
the computer readable mediums further having instructions that (i) automatically compare, during the online auction event, data reflective of respective bids and respective contract options involving those bids; (ii) select from the alternative contract options to award the contract on the basis of the comparisons, (iii) automatically conduct sub-auction bidding events wherein at least one of the alternative contract options includes data reflective of two or more subcontracts, each subcontract awarded in a corresponding sub-auction bidding event for a lot, each sub-auction bidding event therefore being an electronic competitive bid for a lot comprised in the contract; (iv) automatically conduct all the sub-auction bidding events simultaneously by making comparison, during the auction event, between the different bids and between the different options; (vi) during the online auction event, automatically providing each bidding computer of parties involved in a sub-auction bidding event for the related lot data reflective of an option target bid (OTB) indicating a bid that that a party must make for that lot to ensure the option in which that sub-auction bidding event is involved is a leading option in the auction event; (vi) during the online auction event, automatically creating data reflective of a lot target bid (LTB) for each party and transmitting the respective LTB to each bidding computer of parties involved in a sub-auction bidding event, the LTB indicating an electronic bid that that party must make to be a leading bid in the corresponding sub-auction bidding event; and
wherein the computer readable mediums automatically generate an electronic output to cause an indication of a corresponding OTB and LTB from a corresponding sub-auction bidding event to be displayed on a corresponding screen display of at least one bidding party's computer.

27. An administrator computer device for use in a system communicating data over a computer network to automatically conduct an electronic online auction event with multiple simultaneous transactions, the system enabling the administrator computer to communicate with at least two bidding computers over said network, the administrator computer device including:
a processor;
a computer readable medium including instructions to conduct and manage the electronic online auction event;
a network interface; and
wherein the instructions are configured to allow the administrator computer to conduct the electronic online auction event between a controlling party and at least two parties from a prescribed panel of qualified competing bidding parties, each competing bidding party operating a respective bidding computer, the online auction including data in the form of at least two alternative contract options potentially acceptable to said controlling party, one or more of said alternative contract options having a corresponding plurality of different lots, each lot being the subject of a subcontract, which together combine to provide the contract,
wherein the computer readable medium of the administrator computer device includes instructions to receive bids from respective bidding computers, instructions for automatically comparing, during the online auction event, the respective bids and the respective contract options involving those bids, and instructions for automatically selecting from said alternative contract options and for providing automatic notification regarding award of the contract on the basis of the comparisons, wherein at least one of said alternative contract options involves two or more subcontracts, each subcontract able to be selectively and automatically awarded in a sub-auction bidding event for a lot, each sub-auction bidding event therefore being a competition for a lot comprised in the contract, the system further including:
the computer readable medium further having instructions for automatically conducting the online auction by conducting all the sub-auction bidding events simultaneously and making comparison, during the auction event, between the different bids and between the different options;
the computer readable medium further having instructions for, during the online auction event, automatically providing to each bidding computer of parties involved in a sub-auction bidding event for the related lot an option target bid (OTB) display of a bid that that a party must make for that lot to ensure the option in which that sub-auction bidding event is involved is a leading option in the auction event; and
the computer readable medium further having instructions for, during the online auction event, providing to each bidding computer of parties involved in a sub-auction bidding event a lot target bid (LTB) display of a bid that that party must make to be the leading bid in that sub-auction bidding event; and
the computer readable medium further having instructions for automatically generating an output in the form of at least one output on a screen display of one of the computers, the output including an indication of a corresponding OTB and LTB from a corresponding sub-auction bidding event.
